(19) United States
(12) Patent Application Publication
(10) Pub. No.: US 2005/0130644 A1
(43) Pub. Date: Jun. 16, 2005

(54) Cellular telecommunication network using cells of different sizes, corresponding base station, terminal and method

(76) Inventors: Antoine Bassompierre, Paris (FR); Nathalie Goudard, Courbevoie (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/497,282

(22) PCT Filed: Nov. 28, 2002
(86) PCT No.: PCT/FR02/04104

(30) Foreign Application Priority Data
Nov. 28, 2001 (FR) 01/15470

(51) Int. Cl. H04Q 7/20

(52) U.S. Cl. 455/422.1; 455/439; 455/444

(57) ABSTRACT

The invention concerns a cellular communication network comprising at least a first cell, called large-size cell, associated with a first base station and geographically including at least a second cell, called small-size cell, itself associated with a second base station, the first base station managing standby mode for the terminals present in the small-size cell, the second base station capable of taking over communication mode and using a common pilot channel.

This invention is related to cellular radiotelephony. More precisely, the invention relates to data transmission, particularly high throughput transmissions, in a radiotelephony system.

Third generation and more recent radiotelephony systems already handle or will handle many services and applications requiring very high throughput data transmissions. Resources allocated to data transfers (for example files containing sound, and/or fixed or animated images), particularly through the Internet or similar networks, will account for an overwhelming part of the available resource and will probably eventually exceed resources allocated to voice communications which should remain approximately constant.

However, the total throughput available to radiotelephony equipment users is limited. One particular method traditionally used to enable sufficient availability of resources is to increase the density of cells in a given territory. The result is a network infrastructure divided into “micro-cells” that are relatively small cells (for example corresponding to an urban district) or even pico-cells that are even smaller cells (for example corresponding to a street or a building). One disadvantage of such a technique is that it requires a large number of fixed stations (base station (BS)) that are relatively complex and expensive elements. Furthermore, although the possible data throughput is high, it is not optimum. Furthermore, at the higher level, it is clear that management becomes more complex as the number of cells becomes larger.

Moreover, the capacity of third generation UMTS (Universal Mobile Telecommunication System) networks is limited by the power used by the broadcasting channels. The term “broadcasting channel” refers to point to multi-point type channels, for example of the BCH (Broadcast CHannel) or PCH (Paging Channel) type.

This phenomenon is particularly obvious on small cells (pico-cells) that are designed to enable high throughput transmission for mobile equipment with geographically small mobility (for example a few hundred meters).

The various aspects of the invention are intended to overcome these disadvantages in prior art.

More precisely, a first purpose of the invention is to increase the global capacity of a cellular network containing different sized cells, and particularly the global throughput of small cells (pico-cells or micro-cells), while making a minimum number of modifications to the mobile equipment used.

Another purpose of the invention is to use equipment intended for third generation mobile communication networks and requiring no changes or only few changes to existing standards in force, and particularly the UMTS FDD (Frequency Division Duplex) standard (and particularly series 25 in this standard) defined and published by the 3GPP (3^{rd} Generation Partnership project) committee.

For this purpose, the invention proposes a cellular communication network comprising at least one first cell called a large cell, associated with a first base station and geographically surrounding at least one second cell called a small cell, itself associated with a second base station, in particular the equipment in the network possibly being in communication mode when a communication is set up between the equipment and remote equipment, and in standby mode when the equipment is not in communication mode but is present and is available for a communication in one of the network cells, and is remarkable in that the first base station manages standby mode for equipment present in the small cell, while the second base station is able to manage communication mode by using a common pilot channel.

According to one particular characteristic, the cellular network is remarkable in that the first base station manages opening of a communication for equipment present in the small cell, and the network then transfers management of the communication to the second base station.

Thus according to the invention, there is no need for the second base station to manage a channel dedicated to a SCH type synchronisation.

In this way, the invention in particular enables transfer of management of communication or a fast “hand-over” (in other words without listening to the SCH channel) between the large and small cell even if the frequencies are different (making a handover when the frequencies are different is real problem with UMTS).

One advantage of the fast hand-over is that it can reduce the usage time of compressed mode defined by the 3GPP standard when a fast hand-over is required. In this mode, a base station and/or equipment start to transmit at relatively high power at a first frequency, which can create a vacuum that is used to transmit at a second different frequency. Therefore this mode creates interference that adversely affects the network.

According to one particular characteristic, the cellular network is remarkable in that after the communication has closed, the equipment changes to standby mode and is managed by the first base station.

According to one particular characteristic, the cellular network is remarkable in that the second base station comprises means of synchronisation on a synchronisation signal emitted by the first base station, by radio channel (SCH).

According to one particular characteristic, the cellular network is remarkable in that the second base station comprises means of synchronisation on a synchronisation signal emitted by the first base station, through a wire link.

According to one particular characteristic, the cellular network is remarkable in that the equipment deduces its synchronisation on the second base station from the synchronisation on the first base station.

According to one particular characteristic, the cellular network is remarkable in that the synchronisation of the equipment on the second base station is a pseudo-synchronisation tolerating synchronisation errors of the order of 5 to 30 μs.

Thus, the invention is capable of using hardware means usually dedicated to the determination of multiple paths and that are advantageously used in this case to make a fine and fast synchronisation. Thus, the invention enables simple implementation of synchronisation means in base stations and also in user equipment.

According to one particular characteristic, the cellular network is remarkable in that the equipment comprises:
means of analysing multiple paths followed by a predetermined signal emitted by the second base station; and
synchronisation means on the predetermined signal emitted by the second base station, taking account of the analysis of multiple paths;
   the analysis means using a step to determine at least one path corresponding to the predetermined signal input to synchronisation means, the path or one of the paths corresponding to the predetermined signal, called the first path, being considered as the synchronisation base.

According to one particular characteristic, the cellular network is remarkable in that the synchronisation means take account only of the determination of at least one path corresponding to the predetermined signal transmitted by the second base station, the determination being used by the means of analysing the multiple paths.

According to another particular characteristic, the cellular network is remarkable in that the predetermined signal is a signal (CPICH) dedicated to the treatment of multiple paths and emitted by the second base station.

According to one particular characteristic, the cellular network is remarkable in that at least some of its constituent cells operate asynchronously.

According to one particular characteristic, the cellular network is remarkable in that at least some of its constituent cells operate synchronously, with a tolerance on the synchronisation error between them of less than 5 μs.

Thus, in an asynchronous network according to the invention, two large cells are usually not synchronised to each other. On the other hand, small cells may be synchronised or pseudo-synchronised (with some tolerance) on the large cell surrounding them.

According to one particular characteristic, the cellular network is remarkable in that the small cell comprises means of emitting a synchronisation signal (SCH) that the equipment uses to synchronise itself onto the second base station with an error tolerance of less than 5 μs.

Thus, according to this particular characteristic, the small cell does not need to synchronise itself on the large cell but has the disadvantage that it does not enable a fast “hand-over” and consumes pass-band.

The invention also relates to a base station, remarkable in that in a cellular network, the base station called the first base station, will be associated with a cell called the small cell that is itself designed to be geographically surrounded in a cell called the large cell, itself associated with a second base station and geographically surrounding at least one second cell, an equipment in the network in particular being possibly in communication mode when a communication is set up between the equipment and a remote equipment, and in standby mode when the equipment is not in communication mode but is present and available for a communication in one of the network cells,
and in that the second base station associated with the large cell manages standby mode for equipment present in the small cell, the first base station being able to handle communication mode and using a common pilot channel.

According to one particular characteristic, the base station is remarkable in that it is adapted to high throughput communications.

The invention also relates to equipment that will cooperate with at least one base station as described above, remarkable in that the equipment comprises:
means of making a first synchronisation;
means of analysing multiple paths followed by a predetermined signal (CPICH) transmitted by the base station; and
means of making a second synchronisation finer than the first synchronisation, starting from the analysis of multiple paths.

According to one particular characteristic, the equipment is remarkable in that the first synchronisation tolerates synchronisation errors of the order of 5 to 30 μs.

According to one particular characteristic, the equipment is remarkable in that the second synchronisation tolerates synchronisation errors of less than 5 μs.

The invention also relates to a method for management of a cellular network comprising at least one first cell called the large cell, associated with a first base station and geographically surrounding at least one second cell called the small cell itself associated with a second base station,
in particular equipment of the network possibly being in communication mode when a communication is set up between the equipment and a remote equipment, and in standby mode when the equipment is not in communication mode but is present and available for communication in one of the cells in the network, remarkable in that it comprises the following steps:
management of a standby mode by the first base station for equipment present in the small cell; and
handling of the communication mode and use of a common pilot channel by the second base station.

The advantages of the equipment, the base station and the management method are the same as the advantages of the telecommunication network, and they will not be described in more detail here.

Other characteristics and advantages of the invention will become clearer after reading the following description of a preferred embodiment, given as a simple illustrative example that is in no way limitative, with reference to the attached drawings among which:

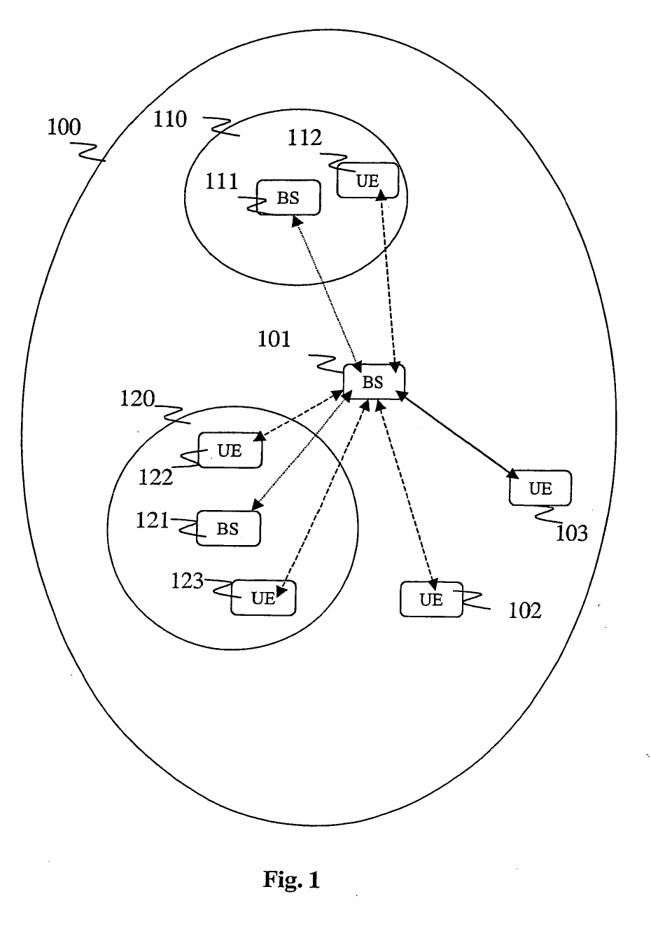

FIG. 1 shows a block diagram of a network according to a particular embodiment of the invention;

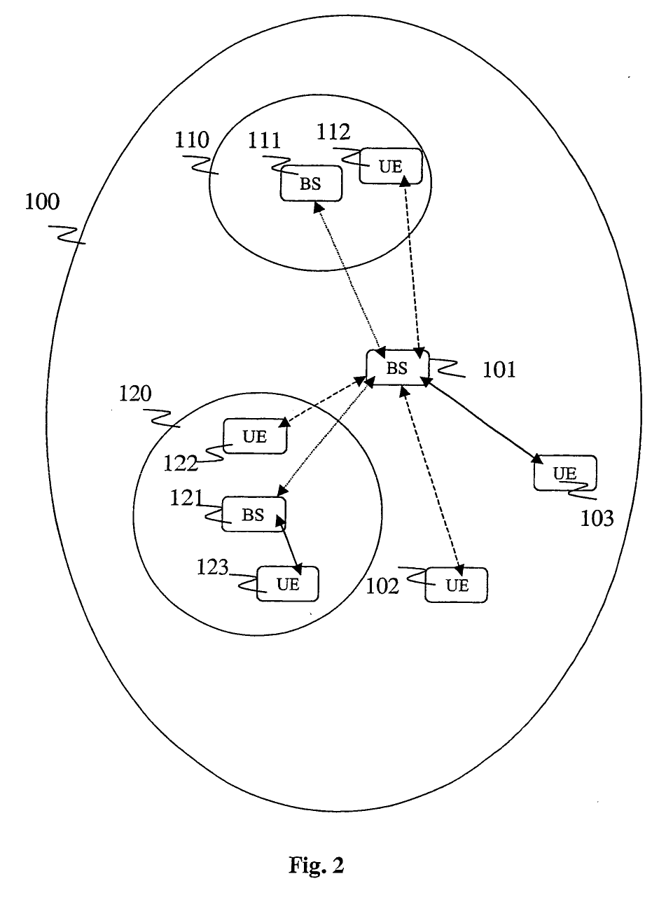

FIG. 2 illustrates the network in FIG. 1 after a communication has been set up between the equipment and the base station associated with a micro-cell;

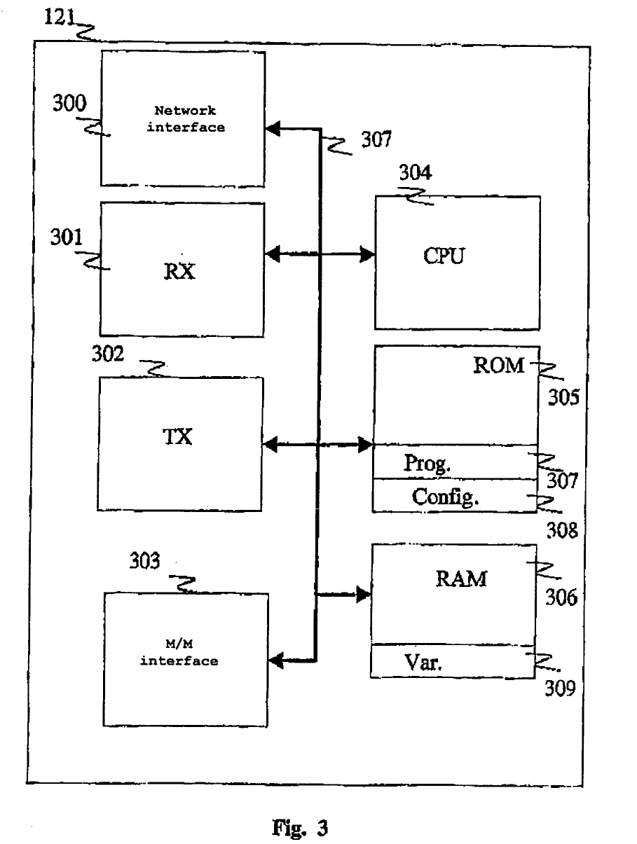

FIG. 3 describes a “micro-cell” base station in the network illustrated in FIGS. 1 and 2; and

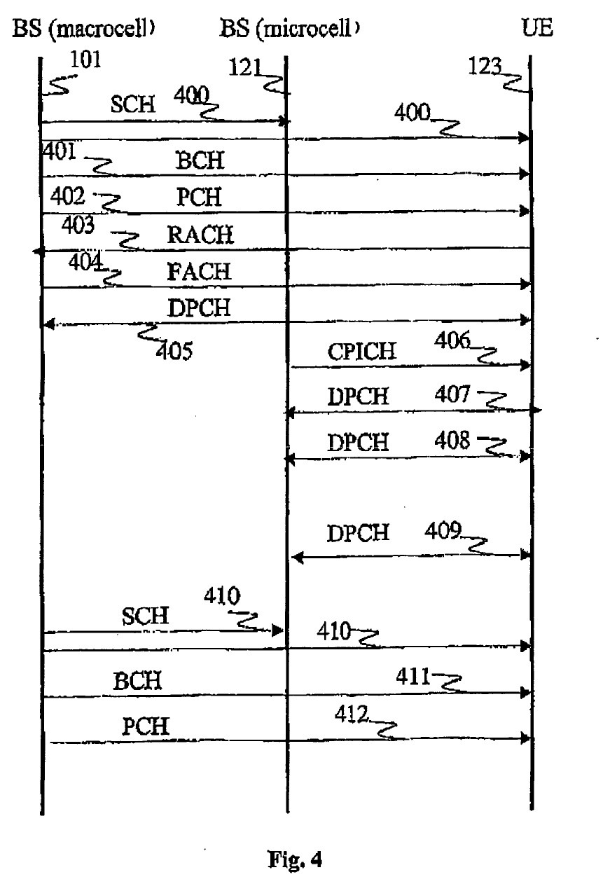

FIG. 4 illustrates a communication protocol between different elements of the network enabling the changeover from a situation illustrated in FIG. 1 to a situation illustrated in FIG. 2.

In the particular embodiment of the invention described below, a network comprising large cells (for example macro-cells) is considered, and some of these cells include smaller cells (for example micro- or pico-cells).

The general principle of the invention is based particularly on pseudo-synchronisation of each small cell on a macro-cell that surrounds it and the management of dedicated channels (data transmission) being applied in small cells, but excluding the management of common channels (or with only limited management of these common channels) (common channels corresponding to point to multipoint links), the user equipment (UE) being attached to the macro-cell surrounding these small cells when the user equipment is in standby.

Note that user equipment consists particularly of mobile or fixed wireless equipment (for example mobile telephones or any other equipment) particularly portable computers (containing a wireless communication system).

Thus according to the invention, user equipment is not directly connected to a pico-cell; in standby mode, if it is present in a pico-cell that is itself included in a macro-cell, the user equipment is managed by this macro-cell on which it depends. In particular it receives signals emitted on the BCH and PCH channels by a base station in the macro-cell. The pico-cell is then accessible to the equipment only by means of a “hand-over”, in other words by a cell transfer managed and decided upon by the network.

Thus, the beginning of a communication, in other words opening of the dedicated channel, is done on the macro-cell. The next step is that the equipment changes over to the pico-cell. The equipment does not need any system information normally broadcast by a BCH (Broadcast CHannel) channel or equivalent that would be specific to the pico-cell.

Thus, according to the invention, the functions of the pico-cell that in particular does not support equipment in standby mode, are restricted. This restriction in the functions performed by the pico-cell is not a disadvantage, since small cells are mainly intended for managing channels reserved for high throughput data transmissions rather than for management of mobiles in the standby state, but is an advantage since the base station of the pico-cell is very much simplified.

At the end of a communication on the pico-cell, the equipment returns to standby mode on the macro-cell.

Moreover, synchronisation channels SCH are not necessary for the “hand-over” of the macro-cell to the pico-cell since firstly the hand-over is pseudo-synchronous, and secondly the destination cell is a pico-cell and therefore it is very small. Therefore this “hand-over” can be made directly, for example by searching for echoes on the pilot channel of the pico-cell (CPICH), the time uncertainty being very short.

Note that synchronisation between pico-cells and the macro-cell does not have to be very precise, according to the approach used in the invention. Thus, a mechanism for pseudo-synchronisation of the pico-cell onto the macro-cell based on the base station of the pico-cell listening to the SCH (Synchronisation Channel) channel of the macro-cell to which it is connected can be used. Considering the very small drifts in the frequency references of base stations, all that is necessary is that the pico-cell should be frequently re-synchronised onto the macro-cell.

According to one variant, the pico-cell may be pseudo-synchronised onto a macro-cell by a wire link between the base stations in each of the two cells.

When a pico-cell is pseudo-synchronised on a macro-cell, a synchronisation error of a few “chips” (the duration of one “chip” is equal to 0.26 micro-seconds in the UMTS standard) in the synchronisation of the equipment on the macro-cell does not make it difficult for the equipment to synchronise itself on the pico-cell.

According to another variant of the invention, a pico-cell uses its own SCH channel which enables asynchronous operation of the pico-cell with respect to a macro-cell that surrounds it. The disadvantage of this embodiment is that this involves an asynchronous “hand-over” for changing over from the macro-cell to the pico-cell, in other words a “hand-over” between two asynchronous cells. However, an asynchronous “hand-over” is a procedure that takes time, particularly in the case of a “hand-over” with a frequency change as is the case here.

The pilot channel is the only indispensable common channel, it enables the mobile to see that it is in the coverage area when it is not connected to the pico-cell. It is also used for the “hand-over” from the macro-cell to the pico-cell.

However, the general principle of asynchronism of the UMTS network is not completely modified. Only the pico-cells operating in the mode described above are pseudo-synchronous with the macro-cell on which they depend. Thus, two pico-cells depending on different macro-cells are not synchronous.

It is important to note that the invention does not require that all pico-cells in UMTS networks should be adapted. Some pico-cells in the same network may operate using the mechanism according to the invention, while all other pico-cells have distribution channels like those proposed by the UMTS standard now in force.

We will now describe a block diagram of a mobile radiotelephony network using the invention, with reference to FIG. 1.

For example, the network may be compatible with the UMTS (Universal Mobile Telecommunication System) standard defined by the 3GPP committee.

The network includes a large cell 100 (or macro-cell) managed by a base station 101 (BS).

This cell 100 surrounds two smaller cells 110 and 120 (“micro-cell” or “pico-cell”).

Each of the cells 110 and 120 comprises a base station 111 and 121 respectively, that can manage communications inside the corresponding cell.

Note for illustration that several items of equipment (UE) are present inside cell 100. Some of these items of equipment are also present in one of the small cells 110 and 120.

Thus, the equipment 112 is inside the cell 110 and therefore can receive or emit signals from or to base stations 101 and 111.

Similarly, equipment 122 and 123 is inside 120 and can therefore receive or transmit signals from or to base stations 101 and 121.

However, equipment 102 and 103 present in cell 100 but not present in one of cells 110 and 120 can emit signals from or to base station 101 but not from or to base stations 111 or 121.

In FIG. 1, the links between the different elements in the cell 100 have been shown at a given instant:
in thin dashed lines for links between base stations;
in thick dashed lines for links between the base station 101 and the equipment in standby state (equipment 112, 122, 123 and 102 according to the example in FIG. 1); and
in solid lines for communication links (link between equipment 103 and base station 101).

Note that some equipment is thus in standby mode, in other words a mode in which equipment is not in communication mode but is present and available for a communication in one of cells 100, 110 or 120. In particular, this equipment is listening to signals emitted by base station 101 belonging to macro-cell 100. These signals are transmitted on:
common transport channels corresponding to services offered to high layers of the communication protocol, particularly BCH (Broadcast Channels) and PCH (Paging Channels) channels; and
common transport channels corresponding to the physical layer of the communication protocol, particularly on CPICH (Common PIlot CHannels) channels.

Note also that in standby mode, the equipment is not listening to the dedicated channels.

On the other hand, equipment 103 is not in standby mode because it is in communication with the base station 101 on a Dedicated CHannel (DCH) which is an up and down channel at the same time.

The channels used by 3GPP networks are well known to those skilled in the art for mobile networks and in particular are specified in the “3^{rd} Generation Partnership Project; Technical Specification Group Radio Access Network; Physical Channels and mapping of transport channels onto physical channels (FDD) release 1999” standard reference 3GPP TS25.211 and published by the 3GPP publications office. Therefore, these channels will not be described here in more detail.

FIG. 2 shows the network in FIG. 1 when some time has elapsed and particularly after a communication has been set up between the equipment 123 and the base station 121 inside the micro-cell 120.

Note that according to FIG. 2, the equipment 123 is directly connected to the base station 121 through an up or down dedicated channel DCH enabling transport of the channel and/or exchanged data.

FIG. 3 diagrammatically illustrates the base station 121 as illustrated with reference to FIGS. 1 and 2.

The base station 121 comprises the following, connected to each other by an address and data bus 307:
a processor 304;
a RAM 306;
a non-volatile memory 305;
a wire network interface 300 making a connection to a fixed infrastructure of the mobile network or to other networks;
a radio reception interface 301 for receiving signals emitted by equipment in communication with the base station 121 on dedicated up channels and signals emitted by the base station 101, particularly on the Synchronisation CHannel SCH (note that current UMTS standards do not require that the SCH channel is listened to only by user equipment and not by a base station;
a radio transmission interface 302 for emitting signals on dedicated down channels and on common transport channels corresponding to the physical layer (and not to upper layers of the communication protocol) (particularly the CPICH channel); and
a man/machine interface 303 enabling a dialog with the machine for control and maintenance.

The RAM 306 stores data, variables 309 and intermediate processing results.

The non-volatile memory 305 keeps the following in registers which, for convenience, have been given the same names as the data stored in them and particularly.
the operating program of the processor 304 in a “prog” register 310 and
configuration parameters 311 for the base station 121.

Note that the base station 121 is implemented more easily than the base station 101 and in particular includes a simpler operating program than the operating program of the base station 101, since it does not include common channel functions that the base station 121 does not need to manage.

According to one variant embodiment of the invention described in FIG. 3, the base station 121 is not synchronised on the SCH channel of the base station 101. Therefore according to this variant, the radio reception interface 301 can receive signals emitted by equipment in communication with the base station 121 on dedicated up channels and does not receive signals emitted by the base station 101 and particularly on the Synchronisation CHannel (SCH). Moreover, the wire network interface 300 enabling a link to a fixed infrastructure in the mobile network or to other networks receives a synchronisation signal emitted by the base station 101 on the wire network or on a dedicated link connecting the base stations 101 and 121.

The synchronisation signal is used according to various techniques known to those skilled in the art (for example pulse at a given rate or a particular bit sequence onto which the base station 121 fixes its own synchronisation). Therefore this synchronisation signal will not be described further herein. Note that the wire synchronisation requires a wire link. On the other hand, wire synchronisation enables a saving of the pass band on the radio medium and is very reliable and is not affected by radio interference.

Note that each equipment (not shown) comprises the following, connected to each other through an address and data bus:
a processor;
a RAM;
a non-volatile memory;
a radio reception interface enabling it to synchronise itself in standby mode onto an SCH type signal emitted by the base station 101, and then in communication mode onto a CPICH type signal emitted by the base station 121, and in general to receive signals emitted by base stations 101 and 121, on dedicated down channels;
a emission radio interface capable of emitting signals on dedicated up channels and on common up transport channels; and
a man/machine interface enabling dialog with the machine for control and maintenance.

FIG. 4 illustrates a communication protocol between base stations 101 and 121 and the equipment 123 when changing from the situation illustrated with reference to FIG. 1 in which the equipment 123 is in standby mode to a situation illustrated with reference to FIG. 2 in which the equipment 123 is in communication with the base station 121.

The base station 101 emits a signal 400 on the down channel SCH to base stations and equipment present in the macro-cell 100 and particularly the base station 121 and the equipment 123. Thus, the base station 121 and the equipment 123 (which is in standby mode, as can be seen in FIG. 1), are synchronised on the SCH channel of the base station 101.

Note that the base station 101 emits this SCH signal regularly and that as soon as the pseudo-synchronisation of the base station 121 degrades below a given predetermined threshold, the base station 121 is resynchronised on the base station 101.

Note also that the base stations 101 and 121 are fixed and therefore the propagation time of the signal between these two stations is known. Thus, knowing this propagation time, the synchronisation of the equipment on base station 121 can be improved by using:
a delay in the synchronisation of the base station 121 with respect to the signal SCH emitted by the base station 101, for example this delay being equal to the propagation time of the SCH signal between the base stations 101 and 121; and/or
a “hand-over” signal (signal 405 described in detail later) emitted to the equipment 123 and carrying information indicating the position of the synchronisation.

The base station 101 also emits a signal 401 on the BCH channel. This down signal indicates which PCH channel the equipment 123 should listen to. Thus, after reception of this signal, the equipment 123 puts itself into listening on the PCH channel indicated by the signal 401.

The base station 101 then emits a signal to the equipment 123 on the PCH channel indicated by the signal 401, this signal being used to detect an incoming call.

Then, assuming that the equipment 123 would like to initialise a communication, it sends a signal 403 on the RACH (Random Access CHannel) channel that is a common channel corresponding to a high layer channel access service)), this signal 403 notifying the base station 101 that the equipment 103 is asking for a communication to be set up.

The base station 101 then emits a communication channel allocation signal 404 on the FACH (Fast Access CHannel) channel that is also a common channel corresponding to a high layer service).

The communication is then set up between the equipment 123 and the base station 101. One or several signals 405 containing data corresponding to an application of the equipment and then control data dedicated to the handover are thus exchanged on the bi-directional channel DPCH.

Note that the hand-over of a communication from the equipment 123 to the base station 121 is made following a network decision (particularly from the RNC (Radio Network Controller) connected to base stations 101 and 121) as a function of multiple criteria, particularly the throughput, communication quality and specific features of the base station 121 (particularly the fact that it is adapted to manage high level communications).

The network situation will then be illustrated with reference to FIG. 2.

The equipment 123 then puts itself into listening on the pilot channel 406 CPICH that according to the invention refines the synchronisation of equipment 123. If the cell 120 is small and the base station 121 is pseudo-synchronised (in this context, pseudo-synchronisation means synchronisation with a precision of less than 50 μs, and preferably less than or equal to 30 μs) onto station 101 (in other words if the synchronisation between cells 120 and 100 is coarse and imperfect, the synchronisation error being less than about 50 μs and preferably 30 μs in synchronised networks known in themselves, the error on the synchronisation will be less than 5 μs), the resulting synchronisation error between the equipment 123 and the base station 121 can be compensated by use of the signal 406. The equipment 123 includes means of taking advantage of multiple paths affecting a signal emitted by a base station (this multiple paths phenomenon is well known to those skilled in the art and in particular is the result of reflections of a signal on obstacles and emitted in several directions, the different received signals originating from the same emitted signal but having followed different paths, usually have different amplitudes and are out-of-phase). Note that in particular, a “rake” type receiver can determine the different delays affecting a multi-path signal. Thus, if the delay is not too great (in other words is less than 20 μs in the context of the 3GPP standard), the equipment 123 is capable of synchronising itself on the CPICH channel.

Thus, assuming that a first path is determined at a precise instant that depends on the synchronisation with the base station 101, the receiver of equipment 123 fixing itself on this hypothetical path searches for at least one path corresponding to a signal emitted on the CPICH channel of the base station with means also used for the determination of multiple paths in a signal emitted on a CPICH channel. This is possible because synchronisation differences between the equipment 123 and each of the base stations 101 and 121 are small. The path or one of the determined paths is then used as the basis for synchronisation of the equipment 123 onto the base station 121.

Note that in the context of 3GPP, the CPICH can be used to process multi-paths with a delay of 20 μs, which provides a means of compensating for an error when the radius of the small cell is less than or equal to about 6 km (namely the delay equal to approximately 20 μs in this case multiplied by the speed of light).

Note also that when it is synchronised on the base station 121, the equipment 123 maintains slaving on this synchronisation through the CPICH channel managed by the base station 121.

The equipment 123 and the base station 121 then exchange data on the dedicated channels DPCH through several signals 407 to 409, of which only a small part has been shown.

At the end of the communication, the equipment 123 and/or the base station 121 indicates that the communication has terminated, through the signal 409.

According to one variant not shown, the network imposes that the equipment should make a “hand-over” to the base station 101 before the end of communication. Note that this “hand-over” can be made quickly with synchronisation on the CPICH signal emitted by the base station 101 since the equipment is synchronised on the base station 121 which is itself pseudo-synchronised on the base station 101.

Therefore, the equipment 123 goes back into standby mode and the situation then becomes the same as that illustrated with reference to FIG. 1.

The base station 101 then transmits signals 410, 411 and 412 on the SCH, BCH and PCH channels respectively, these signals being similar to signals 400, 401 and 402 respectively described above.

Obviously, the invention is not limited to the example embodiments given above.

In particular, those skilled in the art will be able to make any variant to the definition of channels that are not supported by the small cell. Thus, it could be considered that the base station of the small cell can em it a SCH type signal, the equipment then being synchronised on this signal when they are in communication with this base station.

Note that the invention is not limited to UMTS or 3GPP networks, but is applicable to any other cellular network in which large cells surround smaller cells.

Note that the invention is not limited to a purely hardware installation, but it can also be implemented in the form of a sequence of instructions in a computer program or in any hybrid form comprising a hardware part and a software part. If the invention is partially or completely implemented in a software form, the corresponding instruction sequence could be stored in a storage means that is removable (for example such as a diskette, a CD-ROM or a DVD-ROM) or is not removable, this storage means being partially or completely readable by a computer or a microprocessor.

1. Cellular communication network comprising at least one first cell associated with a first base station and geographically surrounding at least one second cell associated with a second base station, an equipment the network possibly being in communication mode when a communication is set up between the-equipment and remote equipment, and in standby mode when the-equipment is not in communication mode but is present and is available for a communication in one of the network cells, characterized in that the first base station manages standby mode for equipment present in the second cell, the second base station being able to manage communication mode and using a common pilot channel.

2. Cellular network according to claim 1, characterized in that the first base station manages opening of a communication for equipment present in the second cell, and the network then transfers management of the communication to the second base station.

3. Cellular network according to claim 2, characterized in that after the communication has closed, the equipment changes to standby mode and is managed by the first base station.

4. Cellular network according to claim 1, characterized in that the second base station comprises means of synchronization on a synchronization signal emitted by the first base station, by radio channel.

5. Cellular network according to claim 1, characterized in that the second base station comprises means of synchronization on a synchronization signal transmitted by the first base station, through a wire link.

6. Cellular network according to claim 4, characterized in that the equipment deduces its synchronization on the second base station from the synchronization on the first base station.

7. Cellular network according to claim 6, characterized in that the synchronization of the equipment on the second base station is a pseudo-synchronization tolerating synchronization errors of the order of 5 to 30 μs.

8. Cellular network according to claim 6, characterized in that the equipment comprises:
means of analyzing multiple paths followed by a predetermined signal emitted by the second base station; and
synchronization means on the predetermined signal transmitted by the second base station, taking account of the analysis of multiple paths;
the analysis means using a step to determine at least a first path corresponding to the predetermined signal input to synchronization means, the first path being a synchronization base.

9. Cellular network according to claim 8, characterized in that the synchronization means take account only of the determination of at least one path corresponding to the predetermined signal emitted by the second base station, the determination being used by the means of analyzing the multiple paths.

10. Cellular network according to claim 8, characterized in that the predetermined signal is a signal dedicated to the treatment of multiple paths and emitted by the second base station.

11. Cellular network according to claim 1, characterized in that at least some of its constituent cells operate asynchronously.

12. Cellular network according to claim 11, characterized in that at least some of its constituent cells operate synchronously, with a tolerance on the synchronization error between them of less than 5 μs.

13. Cellular network according to claim 5, characterized in that the second cell comprises means of emitting a synchronization signal that the equipment uses to synchronize itself onto the second base station with an error tolerance of less than 5 μs.

14. A first base station, characterized in that, in a cellular network, the first base station will be associated with a second cell that will be geographically contained within a first cell associated with a second base station and geographically surrounding at least one second cell,
an equipment in the network possibly in communication mode when a communication is set up between the equipment and a remote equipment, and in standby mode when the equipment is not in communication mode but is present and available for a communication in one of the cells of the network,
and in that the second base station associated with the first cell manages standby mode for equipment present in the second cell, the first base station being able to handle communication mode and using a common pilot channel.

15. Base station according to claim 14, characterized in that it is adapted to high throughput communications.

16. Equipment that will cooperate with at least one base station according to claim 14, characterized in that the equipment comprises:
means of making a first synchronization;
means of analyzing multiple paths followed by a predetermined signal emitted by the base station; and
means of making a second synchronization finer than the first synchronization, starting from the analysis of multiple paths.

17. Equipment according to claim 16, characterized in that the first synchronization tolerates synchronization errors of the order of 5 to 30 μs.

18. Equipment according to claim 16, characterized in that the second synchronization tolerates synchronization errors of less than 5 μs.

19. Method for management of a cellular network comprising at least one first cell associated with a first base station and geographically surrounding at least one second cell associated with a second base station,
in particular equipment in the network possibly being in communication mode when a communication is set up between the equipment and a remote equipment, and in standby mode when the equipment is not in communication mode but is present and available for communication in one of the cells in the network, characterized in that it comprises steps of:
management of a standby mode by the first base station for equipment present in the second cell; and
handling of the communication mode and use of a common pilot channel by the second base station.
